(19) United States
(12) Patent Application Publication
(10) Pub. No.: US 2017/0246071 A1
(43) Pub. Date: Aug. 31, 2017

(54) APPARATUS AND METHOD FOR MUSCLE, CENTRAL NERVOUS SYSTEM AND VISCERA STIMULATION FOR WHEELCHAIR BOUND PERSONS

(71) Applicants: William J. Schultz, Newport Beach, CA (US); Armia Abdo, Rancho Mission Viejo, CA (US)

(72) Inventors: William J. Schultz, Newport Beach, CA (US); Armia Abdo, Rancho Mission Viejo, CA (US)

(73) Assignee: AlignMed, Inc., Santa Ana, CA (US)

(21) Appl. No.: 15/441,578

(22) Filed: Feb. 24, 2017

Related U.S. Application Data
(60) Provisional application No. 62/301,281, filed on Feb. 29, 2016.

(51) Int. Cl. A61H 7/00

(52) U.S. Cl. CPC A61H 7/001; A61H 2201/165; A61H 2201/1269

(57) ABSTRACT

A garment/device/support system, system and method for a wheelchair bound person includes one or two sleeves that are worn on the arms. The sleeves are connected by straps to a chassis or vest worn on the torso. The straps are affixed using Velcro or other fasteners that transfer motion of the wearer's arms to the chassis or vest. Motion, energy and stimulation are transferred to muscle groups, viscera, organs, and body parts in other parts of the body through the motion of the arms as the user moves about in the wheelchair. A cape may be affixed to the vest including shoulder straps connected to a center back portion and extending to a lower portion for positioning beneath and/or attaching to the user's hips or legs. A seat cushion and belt may be provided.

### CROSS REFERENCE TO RELATED APPLICATION

This application claims the benefit of U.S. Provisional Patent Application Ser. No. 62/301,281, filed Feb. 29, 2016, which is incorporated herein by reference.

### BACKGROUND OF THE INVENTION

Field of the Invention

The present invention relates generally to a garment or article of clothing or component, and more particularly to an article of clothing or component for wear by those that use a wheelchair for mobility.

Description of the Related Art

Quality of life and medical costs for spinal cord and wheelchair dependent patients are one of the greatest concerns to various societies throughout the world, including in the United States. Additionally, patients suffering from spinal or structural maladies are forced to endure dysfunctional physical and psychological adaptations, that included, but are not limited to long term pain, fatigue, poor visceral function, poor vascular function and deterioration of the musculoskeletal physiology and central nervous system stemming from compromised movement, inactivity, and awkward, repetitive movement behaviors, various injuries, that produce muscle imbalances and abnormal postures which facilitate skeletal deterioration, osteoporosis, inflammation, chronic pain, depression and the like.

Tasks involved in activities of daily living are more demanding for those people who use a wheelchair for mobility and like activities which lead to abnormal movement behaviors and poor postural alignment, which makes it more difficult to optimize function in this environment.

Physical fitness activities, the choice of equipment, accessibility to facilities and stratagems for the improvement, restoration and maintenance of physical health and psychological health are limited in their availability and scope of performance for those that use a wheelchair for mobility.

Due to the physical inabilities, compromised function and logistical complications associated with injuries that require a wheelchair for mobility, the lifestyles and lifespans of these populations may result in quicker deterioration.

### SUMMARY OF THE INVENTION

Certain embodiments of the present invention provide an active and passive therapy system including one or more garments that transmit motion of one or both of the user's arms, shoulders, legs and or other areas or extremities to other portions of the user's body.

In certain embodiments, the garments use an anatomic matrix of panels, bands and seams for transmitting motion and/or forces from one portion of the user's body to another portion of the user's body. The panels, bands, seams and/or other components are worn by the user, placed onto the wheelchair, or constructed within garments, or onto garments, worn by the user to provide a support system using a garment/device/framework that connects targeted muscles groups to one another. The components may provide dynamic support that may be coupled with tactile touch, fluid-motion, thermogenesis and tensile resistance, applied on and among muscle tissues to influence the neuromuscular activity of the user. The garments or components may restore, improve and/or maintain bilateral symmetry, joint alignment or anatomical neutral positions of the user.

In certain embodiments, the garments may use panels, band, seams and other components collectively referred to as NeuroBands® brand components although other components are of course possible.

The components may intervene and manipulate the external gravitational forces interpreted by the central nervous system and the sensory and motor pathways used to deliver information and to retain muscle memory. In this manner, components may be used as a controllable external therapy, that simultaneously supports and unconsciously influences neuromuscular activity to provide therapeutic neurological biofeedback, immediately, and over time.

The system may have a carry-over effect of muscle-training when used intermittently. This system may have the combined benefit of being an active and passive therapy. The active component requires only that the user wear it, and the passive therapy is performed unconsciously with no discipline or change in behavior required by the user. Passive therapy is essential to the architype of the patent and the therapeutic benefit of the system.

The dynamic motion of the user's arms may be arm, shoulder, neck, head, trunk and core motion as a user is moving a wheelchair in which the user is seated. The motion may be transferred as motion, stimulation, tension and relaxation, or other actions to one or more areas of the user's body that are otherwise inactive or less active as a result of a wide variety of maladies, including injury, birth defect, pain or for other reasons. One or more areas of the user's body that have reduced motion, sensory stimulation, sensory transmission, musculoskeletal activity, circulation, or other reduced use as a result of the user being bound to limited motions a wheelchair allows, at least part of the time may be stimulated or moved by transfer of motion from the parts of the user's body that are moved by the user without any conscious requirement from the user.

The kinetic motion transfer from one muscle group to another may be by straps, belts, panels and/or by portions of the garment/device/support system. For example, panels and/or straps of the garment/device/support system having particular tension transfer characteristics, elasticity, heat, and resistance to stretching or other characteristic may be used for the motion transfer. The panels and/or straps may have oblique, vertical, horizontal or otherwise directional tension transfer so that greater motion provides a transfer, absorption and distribution of force as energy in multi-directional planes. The panels, straps or other garment/device/support system portions may have textures, surface features, grip elements, slip elements, sleeves, channels, layers, heat, or other features that cause some portions to garment/device/support system to grip, absorb, stimulate and otherwise disperse energy from one area of the user's body to be transferred over other areas of the user's body with less, or more stimulation, grip, absorption and dispersing of energy.

A Velcro or other fastener or connector receptive chassis worn on the torso may be used as a station for one or more components to anchor or transfer anterior force loads to posterior muscle groups in the upper extremity and to use elastic, contractual properties of the components to harvest energy from the movements of the upper extremity limbs and transfer it to support and activate targeted muscle groups in the shoulder, neck, scapula, spine, trunk or lower extremity. Likewise, a Velcro or otherwise receptive chassis is worn on the trunk and used as an anchoring and transfer station for the components to transfer force loads to anterior and posterior muscle groups in the upper and lower extremity and to harvest energy from the movement of the trunk and lower extremity limbs and transfer it to support and stimulate targeted muscle groups in the upper and lower extremity.

The garment/device/framework/support system may provide medical, musculoskeletal, orthopedic and/or neurological benefits. In addition, it may provide therapy for improving postural alignment, pain reduction, sleep management, vascularity, symmetry, poise, confidence and visceral functions of a user. The user may use the garment/device/support system during the unconscious process of sleep to manipulate the transfer of loads from one muscle group to another. The user may or may not be a patient who may be treated for medical and/or psychological ailments using the garment/device/support system. The garment/device/support system of certain embodiments provides benefits for patients who require the use of a wheelchair for mobility or other like needs, and may provide benefits for persons who might not require use of a wheelchair. The present application discloses processes and devices and a system to improve the physical and psychological health of those bound to a wheelchair and for other persons as well.

### BRIEF DESCRIPTION OF THE DRAWINGS

FIG. 1 is a front view of a garment/device/support system for wear by a wheelchair bound person according to an embodiment of the present invention;

FIG. 2 is a back view of the garment/device/support system of FIG. 1;

FIG. 3 is a back view of an alternative embodiment of the garment/device/support system of FIG. 1;

FIG. 4 is a front view of another embodiment of a garment/device/support system for wear by a wheelchair bound person;

FIG. 5 is a back view of the garment/device/support system of FIG. 4;

FIG. 6 is a back view of an alternative embodiment of the garment/device/support system of FIG. 4;

FIG. 7 is a front view of a sleeve garment/device/support system for wear by a wheelchair bound person;

FIG. 8 is a perspective view of a person in a wheelchair wearing an embodiment of the present garment/device/support system;

FIG. 9 is a back view of a sleeve being worn on a person's lower leg;

FIG. 10 is an elevational view of a further sleeve according to aspects of the present invention;

FIG. 11 is a side back view of a person in a wheelchair, the person is wearing the vest and a cape according to certain embodiments of the invention;

FIG. 12 is a front view of a person wearing the vest and cape and showing the lower end of the cape attached at the thighs;

FIG. 13 is a top front view of a seat cushion for use with the present system;

FIG. 14 is an anterior view of a glove with variable tensile connectivity;

FIG. 15 is a posterior view of the glove of FIG. 14 on the front and back of the hand that can be receptive and also can be anchored to other components;

FIG. 16 is a front perspective view of a wheelchair on which is positioned a cape similar to the cape shown in FIG. 12 and including a compartment used for a lumbar support; and

FIG. 17 is a front right-hand side perspective view of a wheelchair user in a wheelchair showing a belt on which are provided a lumbar belt support for a retractable device.

### DETAILED DESCRIPTION OF THE PREFERRED EMBODIMENTS

The present invention relates generally to a garment or article of clothing constructed with an anatomic matrix of bands, panels and seams, and more particularly to an article of clothing for wear by those that require a wheelchair for mobility and that includes tension straps, tensile connectivity, and haptic intervention.

The present garment/device/support system, which may be referred to as an InterActive Drive System, may be made of or use specially constructed garment/device/support systems or garment/device/support system portions that connect the appendages of the wearer with muscles, organs, skin and/or connective tissues in other parts of the body to create a functional effect upon the user that is therapeutic. The garment/device/support system may be provided for wheelchair bound persons or other persons. The garment/device/support system can be used in conjunction with physical fitness, wellness, and lifestyle stratagems. The present garment/device/support system can be used as a continuum of care for physical therapy, pharmacological intervention, rehabilitation and injury rehabilitation.

In certain embodiments, controlled resistance is provided to improve muscle performance and joint alignment as a methodology used in physical fitness and physical therapy to correct and maintain anatomic neutral positions, improve joint alignment, aid in healing, in pain management and in overall good posture.

Certain embodiments provide one or more specially constructed garment/device/support systems as a delivery device for biomechanical tensions, tactile touch, tensile resistance, biofeedback and energy harvesting for the user.

The garment/device/support system of certain embodiments provides an InterActive Drive System that uses a specially constructed garment/device/support system chassis that connects the appendages of the wearer to specific anatomy in other parts of the body. The result is a functional effect upon the user that is therapeutic.

In certain embodiments, the garment/device/support system uses adjustable tensile resistance bands, panels and seams incorporated into or synchronized into a garment/device/support system chassis delivery system. The tensile connectivity connects to specific anatomy kinetically to synchronize the neuromuscular physiology that produces motion. Specifically, adjustable tensile resistance is provided connecting the lower and upper arms to spinal, scapular, glenohumeral, scapulothoracic, pectoral, serratus, pelvis, and/or lower extremity portions of the user's body.

The garment/device/support system according to certain embodiments is comfortable to wear and is made of or at least partly made using lightweight, breathable, durable fabrics that wick moisture and incorporate antimicrobial agents. The garment/device/support system may be machine washed and air dried.

Tensile Connectivity

The tensile connectivity is built into and part of a garment/device/support system. The tensile elements may be attached at designated areas of the garment/device/support systems to, for example, transfer motion, energy, stimulation, etc. from one body part to another body part.

The tensile connectivity is dynamic. When the user extends or flexes their arms, the biomechanical tension produced by the arm motion is transferred by tensile elements of the garment/device/support system to apply a controlled resistance on muscles and connective tissue in other portions of the body. Over time, controlled resistance produced by the tensile connectivity, can train the muscles and connective tissue to improve using repetitive, muscle facilitation. The muscles and connective tissues are trained to restore and preserve neutral anatomy.

The tensile connectivity is applied with gentle, directional force on the shoulders, neck and head to facilitate alignment of the anatomy over the core and body's center of gravity. When the head, neck, shoulders, cervical, thoracic or scapula biomechanically strain forward, the resistance bands tighten and provide a gentle pull back. The tensile connectivity and biomechanical support prevents forward head and shoulder postures and dysfunctional scapula positions.

Biofeedback and Neurobiofeedback

The tactile touch, tensile resistance, tensile connectivity and biomechanical restraints apply non-conscious biofeedback, over time, to interrupt and retrain pathological movement habits characteristic of prolonged wheelchair use. The tactile touch tensile connectivity produces conscious biofeedback in the form of body awareness and body schema and nonconscious physical performance improvement. Biofeedback and neuro-bio-feedback produce a carry-over effect even when the garment/device/support system is not being worn.

Tactile Touch

The garment/device/support systems according to the invention may use fabrics and materials with tactile touch upon skin that initiates and/or facilitates an improvement in neuromuscular function. The garment/device/support systems are comfortable and may use lightweight, breathable, durable fabrics that wick moisture and incorporate antimicrobial agents. The componentry can be machine washed and air dried.

Bioenergy Harvesting

The kinetic arrangement and the tensile resistance bands, panels, seams and garment/device/support system, harvests the energy produced by characteristic movements of the limbs and torso, transfers it to activate neuro-mechanical properties of under-used muscles and connective tissue and to help stretch over-used muscles and connective tissue and otherwise correct, maintain and preserve neutral anatomy. Bioenergy harvesting is effective over a relatively short or long period of time. Bioenergy harvesting is a nonconscious therapy that requires little discipline or behavioral modification.

Horizontal Wheelchair Posture and Dynamic Stabilization

The elastic horizontal strapping can support and stabilize horizontal wheelchair posture when attached to anterior anatomy and directed across the user's back or across the wheelchair. The elastic strapping can provide a resistance workout when attached to anterior anatomy and directed across the users back or across the wheelchair.

Device

The device may include one or two sleeves and a vest that may be separate (or separable) from the sleeves or connected to the sleeves. The sleeves and vest attach to one another using elastic attachment bands of various sizes and tensions. The attachment bands allow a customized connection from each sleeve to the vest. The attachment bands can be placed at the vest and around the user or around a chair with a reconnection at the vest to stabilize and improve vertical wheelchair posture.

A function of the certain embodiments of the device is to provide an external physical therapy. A function of certain aspects of the device is to dynamically facilitate a correction and maintenance of anatomic neutral positions in the user's head, neck, shoulder girdle, scapula, scapula-thoracic areas and core musculoskeleture structure. The function incorporates the user's own movement behavior into the device function.

Certain aspects of the invention provide an InterActive™ Drive System. The components of the drive system may include:

A lower and upper arm sleeve with optional Velcro receptivity that connects to chassis and gloves

A vest with modular Velcro receptivity for mounting of any accessories, possibly including variable elastic bands and panels, a chair seat with specific fabric and gel construction with optional, adjustable incline at variable angles, various Velcro or other fasteners attachment points on a wheelchair that are permanent or custom applied gloves with tensile connectivity.

Briefly and in general terms, the present intervention apparatus and method may be directed to an axial and appendicular support system with soft garment/device/support systems and friction straps to extend from the upper appendages to the neck, shoulder, scapulae and along the spine, scapulae, trunk and core. Likewise, an axial and appendicular support system to extend from the lower appendages to the trunk and core. It is envisioned that the apparatus will include additional wheel accessories that can be attached to the garment/device/support system or the wheelchair to further help prevent forward movement or position of the head, neck and shoulder and to maintain a proper upright posture in the spine as well as proper base in the pelvis and lower extremities.

In certain embodiments of the present device, the garment/device/support system includes an InterActive Drive ZOI (zone of influence). The zone of influence may provide a solution that allows the user to adjust the posterior neuromuscular chain without having to reach behind the chassis. The zone of influence is described more fully in a patent application assigned to the same assignee as the present application. The zone of influence can be an added component built into the garment/device/support system. For example, a half-vest chassis may be provided with a zone of influence component.

Certain embodiments of the device and method provide a solution to improve wheelchair posture and quality of life for the user.

Testing of a prototype of the device was performed with the help of several paraplegic and incomplete quadriplegic persons. The persons wore a half vest and attached sleeves in a kinetic alignment to the person's upper torso, front and back. The device provided tensile connectivity to dynamically induce neuromuscular activity sufficient to place the person's neck, scapula and shoulder joint into an anatomic neutral position. The static results were immediate and the dynamic results were nothing short of life-changing. When the person moved, the extension and flexion of the person's arms and upper extremity provided a resistance workout for the levator scapulae, deltoid, triceps, biceps, trapezius, pectorals, serratus posterior and the rotator cuff muscles and the therapeutic result was amazing.

In addition, straps were connected to the vest, at serratus anterior, then horizontally across the back of the wheelchair to stabilize the person's vertical posture (like a seatbelt or restraint at a carnival ride). Again, nothing short of amazing! The device will serve to benefit those with disabilities, a means to take an active role in the way they look and feel. The consistent micro and macro movement provided by a wearable therapy may be the single greatest way to fight the inflammatory process that would otherwise serve to harm quality of life and longevity for this population and the effect is immediate, and the effect is long-lasting when the garment/device/system is worn intermittently. The device and method represents a significant breakthrough in care for paralysis.

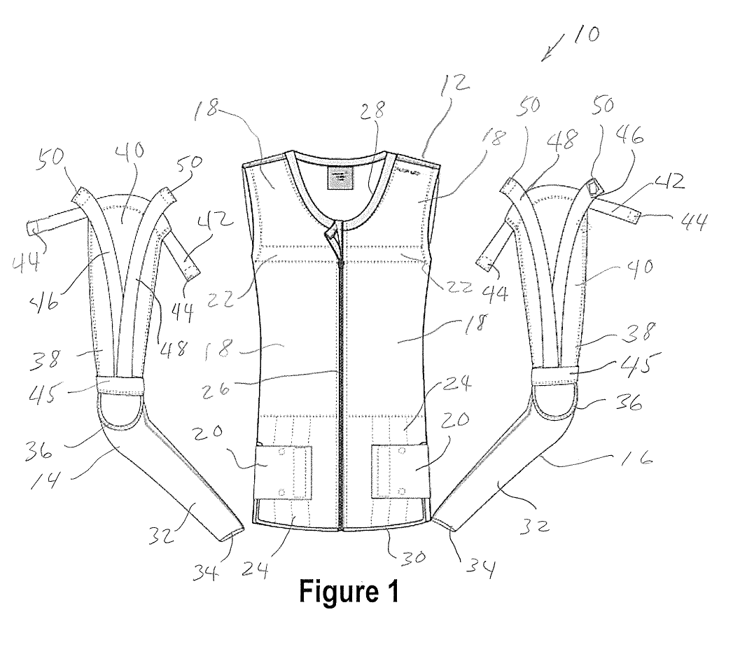

With reference to the drawings, in FIG. 1, a garment/device/support system 10 for wear by a wheelchair bound person includes vest portion 12 and two sleeve portions 14 and 16. The vest portion 12 is worn on the torso of the person. The vest portion 12 includes chest panels 18 that have Velcro receptivity. The Velcro active panels 18 may be only the upper portion of the chest, or may extend over the entire front of the garment/device/support system, or may be a portion thereof. The vest portion 12 is formed of a material that provides core stability by resisting stretching. Tension applied to a portion of the vest 12 is transmitted to other portions of the vest 12. A lumbar support 20 extends about a lower portion of the person's torso.

A reinforced front chest area 22 on the vest 12 extends across the front of the chest of the wearer. The chest area 22 includes two rows of stitching extending across the chest. The stitching may affix reinforcing panels to the inside or outside of the garment/device/support system or attach a reinforcing band or strap, or may provide an anchor or affixing location for straps. A reinforced hip area 24 wraps about the hips of the wearer. The hip area 24 includes at least two layers of material having a defined stretch and tension characteristic and includes multiple vertical stitching to secure the layers together. The vest 12 includes a front zipper 26 on the front of the garment/device/support system extending from a neckline 28 to a hem 30.

The vest 12 is worn with the sleeves 14 and 16. The sleeves 14 and 16 each include a forearm portion 32 that is shaped as a hollow tube. The forearm portion 32 of the illustrated embodiment extends from approximately the wrist of the wearer to the elbow or above the elbow. A cuff hem 34 is provided at the wrist and an elbow hem 36 is provided at the elbow. The forearm portion 32 is connected to an upper arm portion 38. The sleeves 14 and 16 may be formed of elastic material, knit material, or other fabric or material. The sleeves may be formed of a diagonal knit fabric, as compared to a vertical or horizontal knit tube. The diagonal knit may be formed into a tube, either by knitting the tube or by a seam. The seam should be elastic. The yarn of which the knit is formed should be selected to have the desired gauge, stretch, and tension.

The upper arm portion 38 includes a panel 40 that extends from the elbow hem 36 to a position on the shoulder of the wearer. The panel 40 is formed as a strip of material and is positioned to cover only an upper or outer surface of the upper arm. The illustrated embodiment does not wrap around the arm or extend to the under arm or inside of the upper arm of the person. The panel 40 extends to a strap 42 that is mounted transversely at the upper end of the panel 40. The strap 42 has opposite ends 44 provided with Velcro fasteners. When worn, the panel 40 extends from the elbow to the top of the shoulder of the wearer. A reinforcing strap 45 is provided at the elbow. The strap 42 is fastened across the top of the shoulder to connect to the chest panels 18 at the front of the wearer and to a back of the vest 12.

In addition to the panel 40 and strap 42, the sleeves 14 and 16 each include two vertical straps 46 and 48. The vertical straps 46 and 48 extend from the elbow hem 36 to a position extending beyond the top of the panel 40. The vertical straps 46 and 48 each have Velcro fasteners 50 at the upper ends. When worn, the vertical straps 46 and 48 extend from the elbow on the outside of the upper arm to positions on the front and rear of the shoulder of the wearer. The Velcro fasteners 50 are attached to the Velcro receptive panels 18 on the front of the chest and to portions of the vest 12 on the upper back at the shoulder. The vertical straps 46 and 48 may be affixed to the panel 40 or may be free of the panel 40.

As will be understood by those skilled in the art, a person who wears the garment/device/support system 10 as illustrated and who moves one or both arms about, will have motion of the arms transmitted through the sleeves 14 and 16 to the shoulder, chest, back and upper torso of the wearer by the straps 42, 46 and 48 and panels 40. The vest 12 may transmit the motion to the upper torso of the wearer, to the middle of the torso, and to the lower portions of the torso. Viscera of the person is moved and stimulated by the arm motion of the person. The motion may also be transmitted by the material of the vest to the hips and lumbar region of the wearer. Transmitted motion to the hips and lumbar region may stimulate the buttocks, upper legs, and thighs of the wearer.

A wheelchair bound person who is capable of moving their arms to move the wheelchair, such as by grasping and moving the push rims of the wheelchair, may wear a garment/device/support system according to this disclosure to stimulate and move muscles, skin, organs, blood vessels, lymphatic system, and other tissues of the upper, mid and lower torso, of the hips and lumbar region, and even of the buttocks, hips, and upper legs. The beneficial effects may be felt throughout their body. Persons who are confined to a wheelchair and have little opportunity for movement and stimulation of the viscera and tissues of the mid portions and lower portions of the body are able provide movement and stimulation of the previously inactive portions of their body. Organ function and circulation is improved, atrophy is reduced, breathing is improved, and overall health is better.

If the person's disability results in the person only being able to move one arm, only one of the sleeves need be worn. If the person is unable to significantly move both arms, it may be beneficial for the person to wear the vest either with or without the sleeves. The person's posture and breathing is improved.

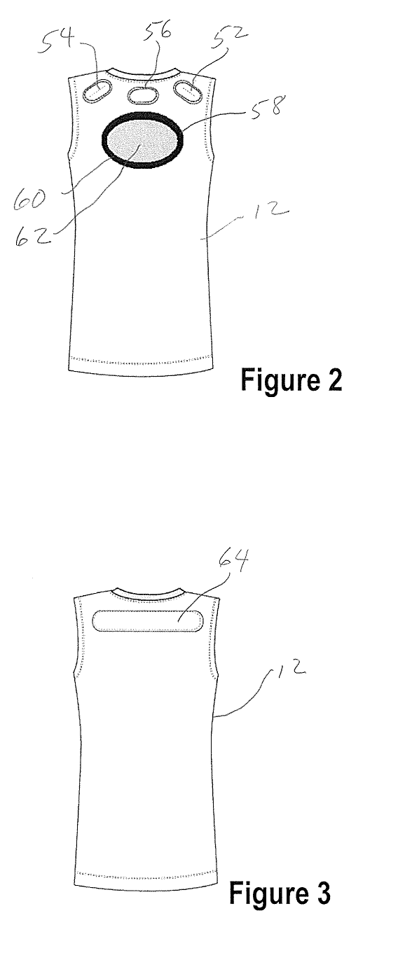

FIG. 2 shows a back of the vest 12. The vest includes Velcro panels 52 and 54 at the back of the shoulders. In addition, a Velcro panel 56 is provided at the top of the center of the spine. The straps 42, 46 and 48 may connect to the Velcro panels 52, 54 and 56. In particular, depending on how the garment/device/support system is worn, one of the straps 46 and 48 may be connected at the front of the chest and the other to one of the Velcro panels 52, 54 and 56 on the back of the vest 12. Other arrangements and connections of the straps may be made or additional straps may be provided depending on the person's disability, posture, health issues, or other reasons.

The back of the vest 12 of this embodiment includes an oval panel 58 located at the center of the back. The oval panel 58 may include a perimeter 60 of an elastic material and a center portion 62 of a further elastic material. The perimeter 60 may be formed of a rubber, latex, or other elastic band or tube formed generally into a circular shape. In certain embodiments, the perimeter material is wrapped in fabric. The center portion 62 may be formed of a stretch material or a resistant material. The center portion 62 may be formed of a plurality of bands or straps arranged parallel with one another or at angles to one another. The bands or straps may cross one another. The center portion may be formed of a single piece. The combination of the vest 12 with the straps connected to the Velcro panels exerts a pull on the wearer from the front of the chest, over the shoulders, and to the back. The oval panel 58 acts on the person's scapula to exert a tension that is transmitted to the shoulders. The individual actions of the panels and straps and the combined action of the panels and straps act to draw the wearer's shoulder's back, straighten the spine, improve posture, open up the chest, and improve breathing. Numerous health benefits are provided.

FIG. 3 is an alternate embodiment of the vest 12 shown from the back. The alternate embodiment includes a Velcro strip 64 extending across the upper back. The Velcro strip 64 provides a connection site for connecting the straps 42, 46 and/or 48.

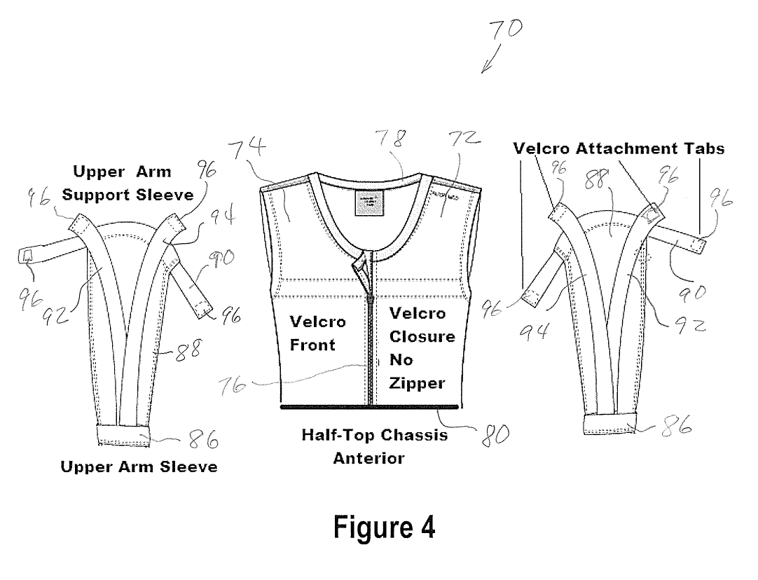

FIG. 4 provides a half top or shortened top 70 having a vest portion 72 that has Velcro active material on the front panel 74. The entire front 74 may be Velcro receptive or only a portion may be of Velcro receptive material. A zipper 76 provides a front closure of the vest 72. A neckline 78 and bottom hem 80 are provided. The bottom hem 80 may extend about the wearer's chest, thorax, abdomen, or other part of their body. The shortened top 70 may be easier for some persons to put on or take off than the longer version of FIG. 1 or may better serve the needs of the wearer.

Sleeves 82 and 84 are provided. The sleeves 82 and 84 include an elbow band 86 that encircle the wearer's arm at or above the elbow. A panel 88 extends from the elbow to a strap 90 that extends transversely at the top end of the panel 88. Two straps 92 and 94 also extend from the elbow band 86 to the top of the shoulder. The straps have Velcro fasteners 96 at their ends. The fasteners 96 may connect the straps to the vest 72 in the same way as described above.

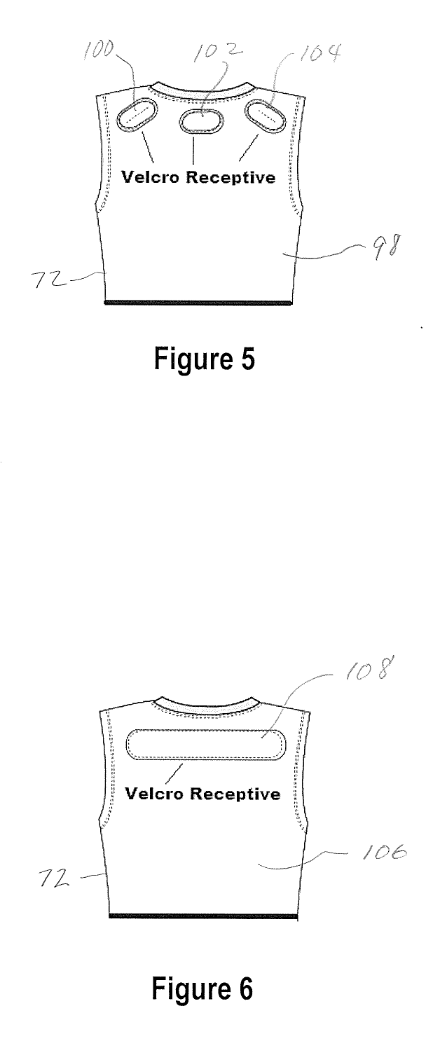

FIG. 5 shows a back 98 of the shortened vest 72. The back 98 includes three Velcro receptive portions 100, 102 and 104 to which ends of the straps 90, 92, and 94 may be attached. The receptive portions 100 and 104 are at the back of the shoulders and the receptive portion 102 is at the center of the back.

FIG. 6 is an alternate embodiment of the vest 72 in which the back 106 has a horizontal strip 108 that is of Velcro receptive material. The straps 90, 92 and 94 may be attached anywhere along the strip 108 instead of just at the attachment sites of FIG. 5.

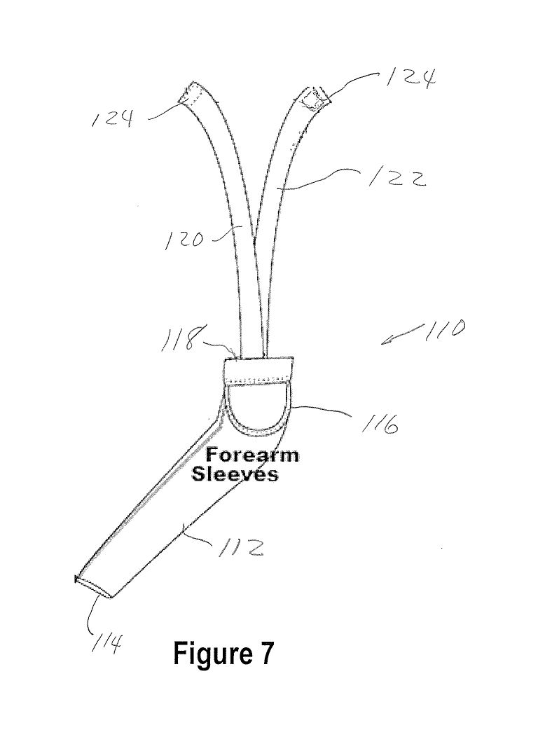

In FIG. 7, a sleeve 110 is provided for wear by a person. The sleeve 110 may be worn with a vest of the type shown herein or with another garment/device/support system. The sleeve may be worn as a single sleeve or in pairs with another sleeve that has a mirror image configuration. The sleeve 110 has a forearm portion 112 that is formed as a tube of fabric having a cuff hem 114 and an elbow hem 116. The forearm portion 112 is connected at the elbow hem 116 to an anchor strap 118 that extends transverse to the wearer's arm and is positioned just above the elbow. The anchor strap 118 connects to two vertical straps 120 and 122. The vertical straps 120 and 122 overlap one another at the anchor strap 118. The straps 120 and 122 diverge from one another and at their free ends are positioned for placement on the front and back of the wearer's shoulder. Velcro fasteners 124 are provided on ends of the straps 120 and 122. The straps 120 and 122 are fastened to a vest or other garment/device/support system so that motion from the user's arms is transferred to other parts of the user's body. For some people, the version with only the vertical straps 120 and 122 may be preferred to the version with the additional panel as shown in FIGS. 1 and 4.

Other configurations of straps and panels and garment/device/support system portions may be provided to harvest motion of the person's arms and transfer the arm motion to motion and stimulation of other body parts.

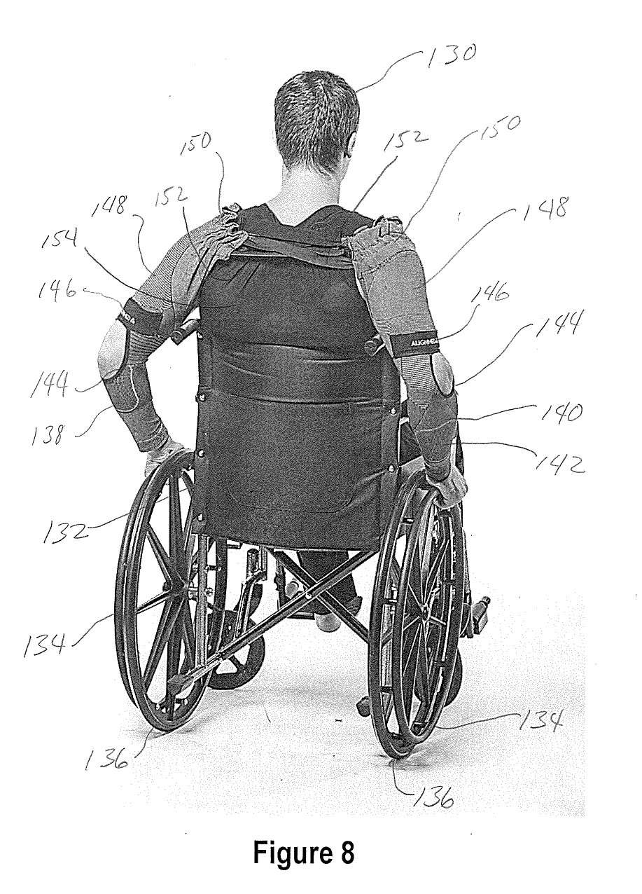

FIG. 8 shows a person 130 in a wheelchair 132. The person has use of their arms and may move the wheelchair. For example, the person 130 may grasp the push rims 134 that are mounted parallel to the large wheels 136 of the wheelchair 132. By pushing and pulling on the push rims 134 or on the wheels 126 themselves, the person may move the wheelchair forward, backward, turn or otherwise move about. The person is wearing sleeves 138 and 140 that have a forearm portion 142 extending from the person's wrist to the person's elbow. The forearm portion 142 is generally snug fitting with limited stretch to the fabric or other material. At the elbow is provided a loop opening 144 in the sleeves 138 and 140 that permits the person to bend their elbow with less restriction on movement.

An anchor strap 146 is provided on each the sleeve 138 and 140 above the elbow. The anchor strap 146 extends partially about the upper arm of the person 130, generally on the outside, forward and rear surfaces of the arm. The strap 146 does not extend to the inside surface of the upper arm. From the anchor strap 146 extends a panel 148. The panel 148 covers the outside of the upper arm and extends to a channel 150 through which passes a transverse strap 152. The transverse strap 152 is drawn tight through the channel 150 and fastened to a vest 154 that is being worn by the person 130. Each strap 152 extends to connector locations on the vest 154 that are adjacent the respective opposite shoulder of the person 130. As a result of the tension on the straps 152, the fabric at the channel 150 is gathered.

In the illustrated embodiment, two transverse straps 152 are provided on each panel 154, extending generally in parallel with one another through parallel channels 150 in the panel 148. Both straps 152 of each sleeve are attached to the vest 154. Vertical straps or other straps may be provided as needed.

As the person 130 moves their arms to move the wheelchair 132 about, the arm motion is transferred by the sleeves 138 and 140 and the vest 154 to the person's torso. Structural and material features of the vest 154 transfer the harvested arm motion to the person's body core, viscera, muscles and organs.

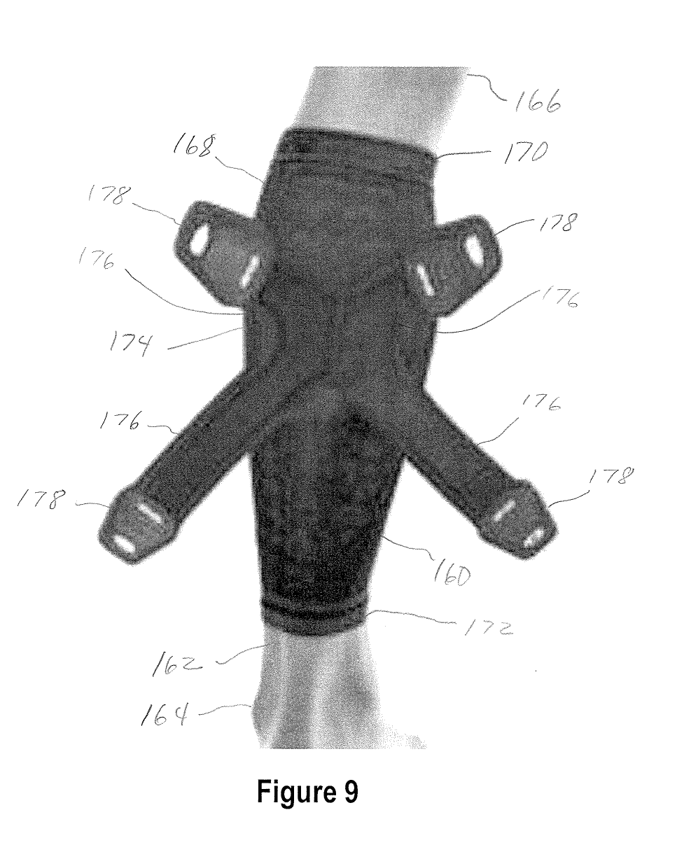

FIG. 9 shows a sleeve 160 that may be worn on a user's arm or leg including on the upper arm, lower arm, upper leg or lower leg. In the illustration, the sleeve 160 is being worn on a lower leg 162 between the ankle 164 and knee 166. The sleeve 160 includes a sleeve body 168 that is generally in the shape of a tube formed of elastic material. The sleeve body 168 may be tapered on one or both ends to better fit the body contours of the wearer. The sleeve body 168 has an upper hem 170 and a lower hem 172. The upper and lower hems 170 and 172 may be folded back on itself or may include an elastic band or may include a skin gripping texture or material, or any combination of these. On the sleeve body 168 is mounted a strap body 174. The strap body 174 may be referred to as a butterfly strap. The strap body 174 of this illustrated embodiment includes four elastomeric strap sections 176 each having a free end with a strap connector 178. The strap connectors 178 may be connected to other straps or to the body of a garment/device/support system or to each other. By connecting the strap connectors 178 to straps that extend to different parts of the body, motion and energy may be transferred from or to the limb on which the sleeve 160 is worn.

The sleeve may be provided on any limb and on either the upper or lower portion of the limb. The sleeve may be provided on a portion of a limb or on the entire limb.

The illustrated embodiment of the sleeve 160 includes the strap body attached to the sleeve body 168 at the calf muscle when worn as shown. Motions transferred to the sleeve 160 by straps connected elsewhere provide stimulation and motion to the calf muscle. The sleeve 160 also provides joint positioning, support, and stability to the limb on which the sleeve 160 is worn.

The straps are modular in that the connectors 178 may be attached to straps of different lengths so that a correct length strap may be provided for each situation. Each of the straps including straps shown in other embodiments illustrated herein, may be provided with connectors to permit selection of a correct length strap for each wearer and each situation. One piece straps or multi-piece straps may be provided. The straps may be of elastomeric material or of a non-elastic material, or both. The straps may be positioned to be crossed or generally parallel. One strap, two, three, four or five straps may be provided.

The tensions provided by the straps may be diagonal, directional, or oblique to the muscle or tissue to which the motion is being applied.

The strap body 174 may have a grouping of fingers that allow the strap to stretch and reach specific muscle groups. The fingers attach to the limb sleeve 160 and grab the targeted muscle groups for proper positioning.

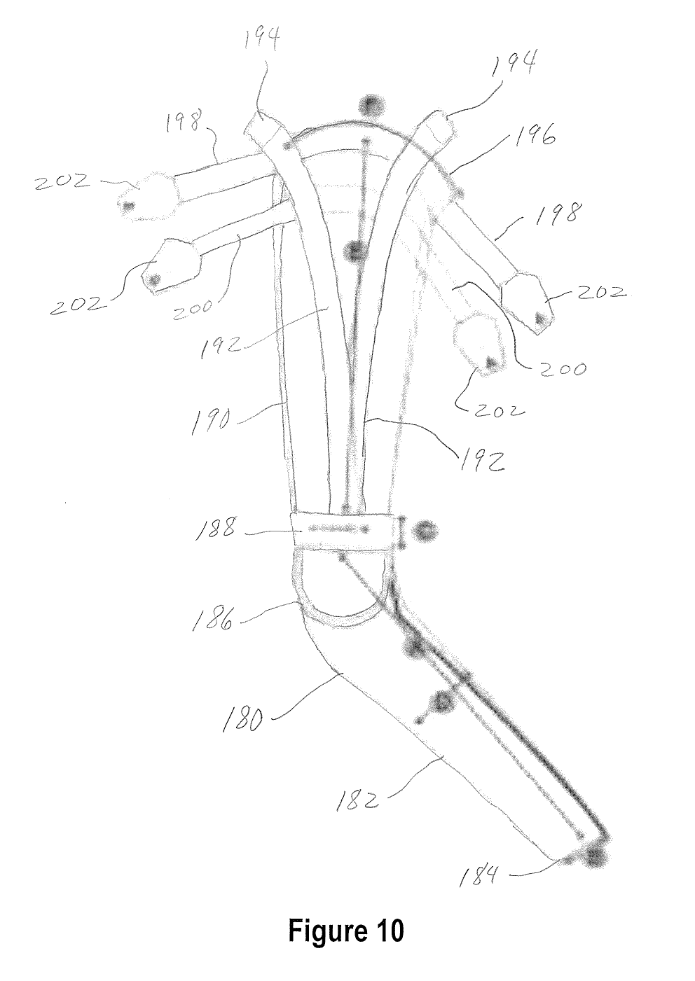

FIG. 10 shows an arm sleeve 180 of an alternate embodiment. The arm sleeve 180 includes a lower arm tubular portion 182 that extends from a wrist hem 184 to an elbow hem 186. A support band 188 is connected at the elbow hem 186. An upper arm cover 190 is connected to the support band 188 in a position to extend over the outside of the upper arm of a wearer. A pair of vertical straps 192 is also connected to the support band 188. Each of the vertical straps 192 has a Velcro fastener 194 at the free end for connection to a Velcro receptive panel of a vest or other garment/device/support system item. The upper arm cover 190 has an upper end 196 that is worn over, at, or near the shoulder of the wearer. The upper end 196 of the illustrated embodiment has two transverse straps 198 and 200 that extend transverse to the upper arm cover 190. The straps 198 and 200 have free ends that are provided with clips 202. The clips 202 are configured to attach to other straps, to attached to other clip portions on a garment/device/support system, wheelchair, or other item, or to attach to each other. The straps 192, 198 and 200 may be of elastomeric material. The straps 192, 198 and 200 serve to transmit motion and energy from a limb being moved to other parts of the wearer's body.

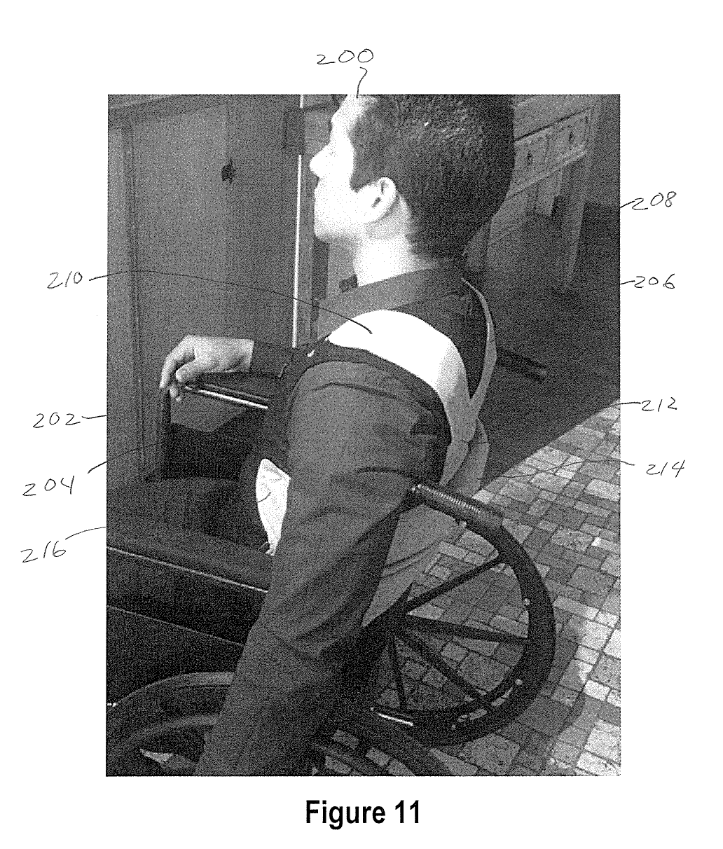

FIG. 11 is a side view of a person 200 in a wheelchair 202 that is wearing the vest 204 similar to the vest as described above. The vest fits onto the torso of the person 200. A cape 206 has been attached to the outside of the vest 204. The cape 206 includes two shoulder straps 208 and 210 that extend from the back of the person 200 over the shoulders of the person 200 to the upper chest area of the person and attach to the vest 204, such as by Velcro fasteners, at the upper chest area of the person. The cape 206 includes a center back panel 212 that extends along the back of the person wearer. The lower portion of the cape 206 is not visible behind a back rest 214 of the wheelchair 202 but may extend to the seat area of the person. The cape 206 of the illustrated embodiment includes side sections 216 that extend from the center back panel 212 and/or the lower portion of the cape 206 forward at the sides of the wearer's torso and attach to the vest 204 at the sides or front of the person's torso. The cape 206 may be of a stretchable and breathable fabric that exerts tension and that transmits motion between portions of the wearer's body by the tension. For example, motion by the user's arms and shoulders may be transferred by the cape 206 to lower portions of the person's body. The cape 206 may extend along the wearer's back for example to the torso, to the waist, or lower. The cape 206 extends over the scapula area of the wearer 200. The energy transfer by the cape 206 and vest 204 helps to prevent sores in the gluts and captures energy from motion and transfers it to the body core and the scapulas.

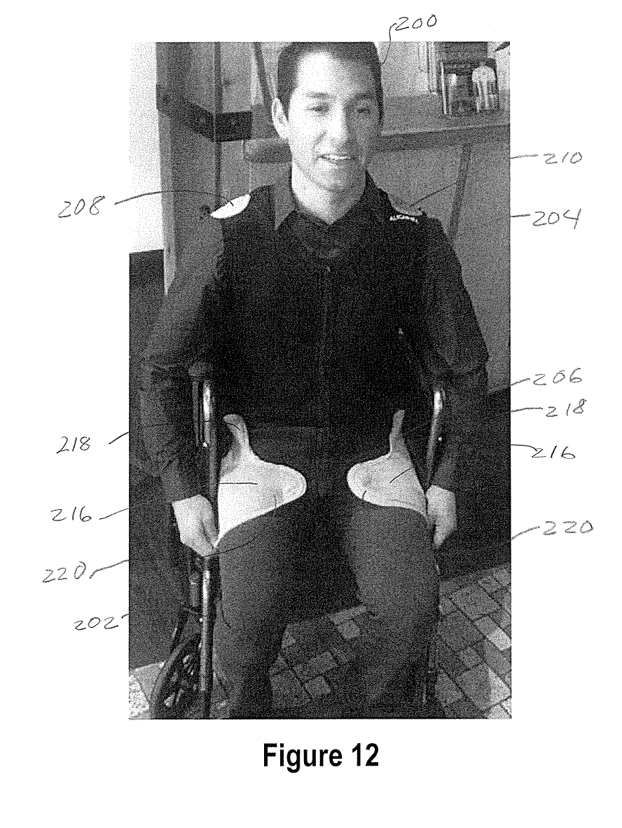

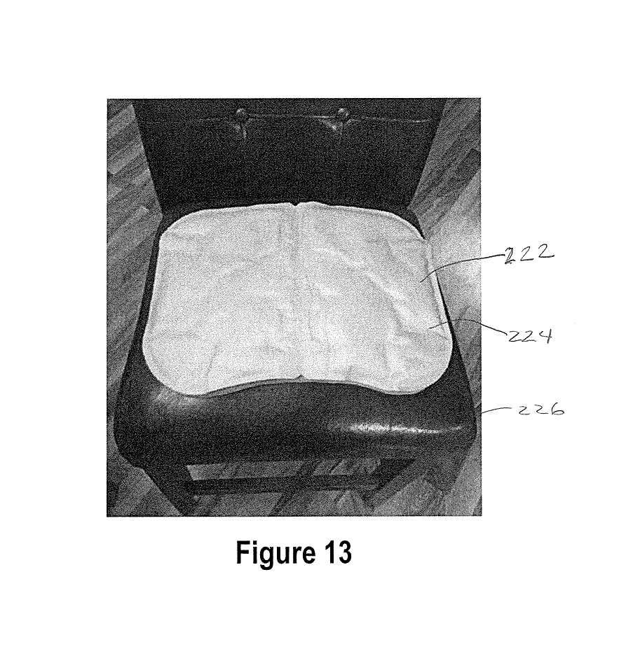

In FIG. 12, the person 200 is wearing the vest 204 with the cape 206 attached to the vest 204. The ends of the shoulder straps 208 and 210 are attached to the tops of the wearer's shoulders instead of extending over the shoulders to the front of the person's chest. The cape 206 is shifted lower on the person compared to the prior view so that the lower portion of the cape 206 extends beneath the wearer's buttocks and upper legs. The side sections 216 at the lower portion of the cape 206 have been wrapped from beneath the person's buttocks and upper legs to extend around the person's upper legs. The side sections 216 attach at the front or upper portions of the wearer's thighs by Velcro fasteners or other fasteners. The side sections 216 may include a wider portion 218 that extends from the center back panel 212 and extensions 220 that extend from the wider portions 218. The side sections 216 may include one or more fasteners, such as Velcro fasteners, including at the extensions 220. Motions of the wearer's shoulders are transmitted by the vest 204 and cape 206 down the back and to the buttocks, thighs, and upper portions of the legs of the wearer. When the person 200 uses his or her arms and shoulders to move the wheelchair, to reach for objects or for other motions, those motions are transferred to stimulate the core and lower portions of the person's body. To various extent, these effects may be provided by the vest alone, by the vest and cape worn together, or by the cape when worn with other articles of clothing.

FIG. 13 shows a gel seat cushion 222 or other seat cushion that may be provided beneath the wheelchair user's buttocks and/or legs. The seat cushion 222 includes an outer cover 224 within which is provided a gel or other fluid, semi-fluid, or solid material as a filling. The seat cushion 222 is shown on a chair 226. The cushion 222 may be placed on a wheelchair or other seating apparatus. The gel or other filling may move about within the cover to vary pressure points, for example, between the chair and the person 200. The seat cushion 222 may be placed between the chair and the cape or between the cape and the person's body, for example. Motion transmitted by the cape or other garment that extends beneath the person's buttocks may be transmitted to the tissues of the buttocks and upper leg by the gel seat cushion. The seat cushion may have Velcro or other fasteners on the underside of the seat to hold it to the cape 206 so as to be maintained in desire positions beneath the wearer to prevent displacement and for best therapeutic effect. A cape 206 or other garment that has Velcro fasteners may be attached to the seat cushion at Velcro receptive portions of the seat cushion, for example that may be on the underside of the cushion. The energy transfer to and through the seat cushion as a result of motions by the arms and other portions of the wearer's body being transferred to the seat cushion helps to prevent sores on the gluts, for example. Energy is transferred from the scapulas and other portions of the body via the cape and other energy transfer elements to other parts of the wearer's body.

A cushion of certain embodiments may be provided with an inclined top surface at the back portion of the cushion. For example the cushion may have a back top surface inclined at an angle of five degrees or ten degrees or may have no incline. In certain embodiments, a seat cushion may be provided that is adjustable by height and angle.

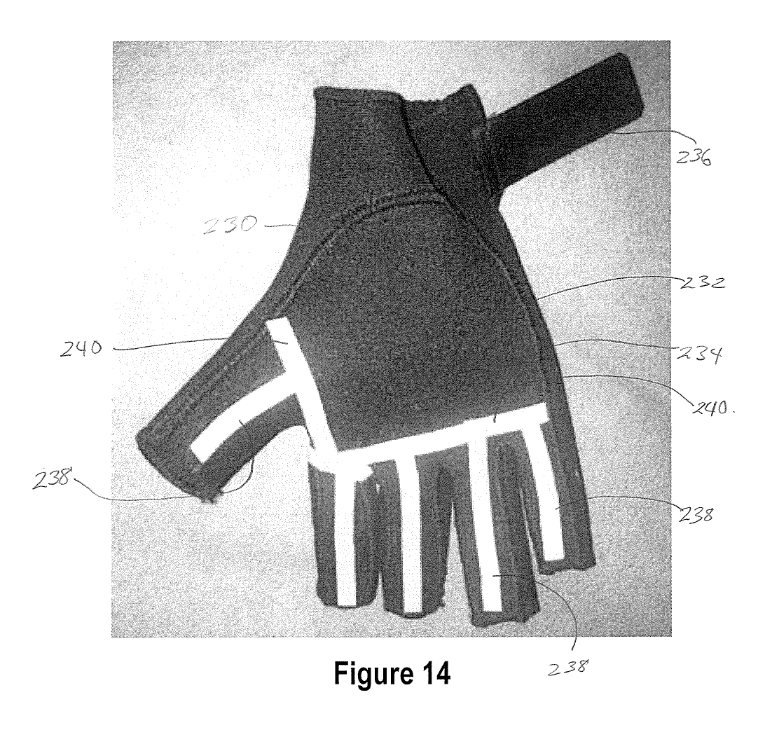

FIG. 14 is a glove 230 for wear by a wheelchair user, shown from the anterior side or palm side 232 of the glove. The illustrated glove 230 is shaped for wear on the right hand. A left hand glove is also provided with a symmetrical construction. The glove 230 includes a body 234 of stretch fabric such a neoprene with a Velcro wrist strap 236 to secure the glove in place on the person's hand. Tension strips 238 are applied to the glove extending along each finger and thumb and further tension strips 240 extending transverse to the fingers at the joint joining the fingers and at the joint joining the thumb to the palm. The tension strips 238 and 240 may be affixed to sleeves that the wearer is wearing, such as sleeves as described and shown elsewhere in this specification. Fasteners may be provided at or near the tension strips for fastening the sleeves, straps or other components to the strips 238 and 240 of the glove 230. The tension strips 238 and 240 of the gloves 230 operate to capture energy of the wearer's hand movements and transfer the energy for improved grip strength. The tension strips may be applied to the glove or formed into the glove. The illustrated glove 230 is a half finger glove. Full finger gloves may also be provided with these features. The glove connects to the sleeves on both sides of the forearm.

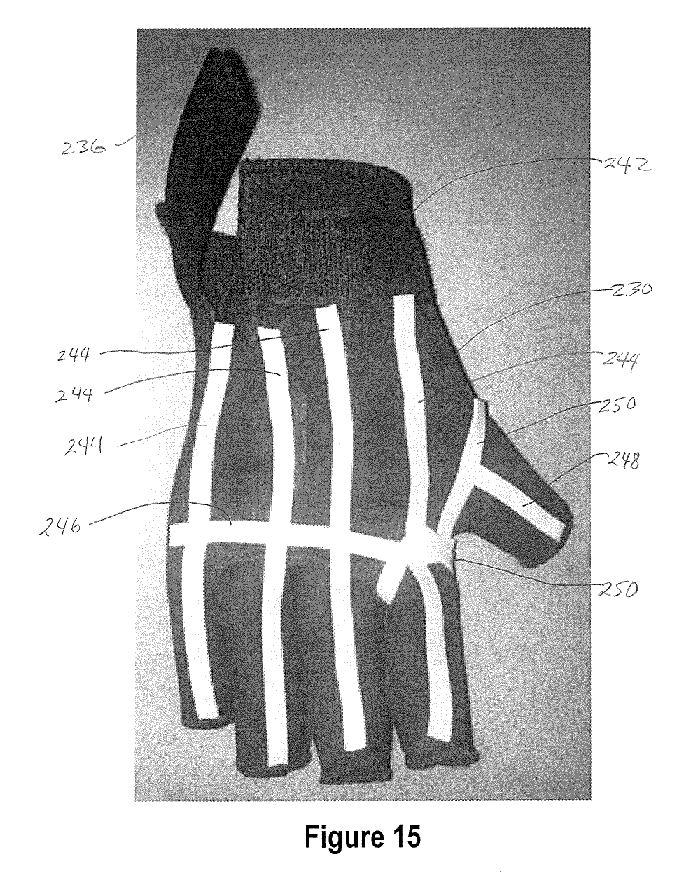

FIG. 15 shows the glove 230 from the posterior side or back side of the hand. The Velcro wrist strap 236 permits adjustment to fit the user, such as by attaching the strap 236 to a Velcro receiving portion 242 at a wrist band. Tension strips 244 extend from the wrist band 242 to the end of each finger of the glove 230. A transverse tension strap 246 extends across the portion of the glove that covers the knuckles. A tension strap 248 extends the length of the thumb portion of the glove to a transverse strap 250 disposed where the thumb and body of the hand meet. A transverse strap 252 at the base of the first finger connects the straps 246, 250 and the strap 244 of the first finger to one another and wraps at least part way around the finger. The tension straps may be affixed to sleeves by fasteners or the like. Both sides of the glove may connect by straps or otherwise to the sleeves.

The glove 230 as shown is generally provided with a matching glove for the other hand of the user. The gloves are provided with connections to the sleeves worn on the forearms of a user at both sides of the glove. The connection between the gloves and sleeves allow the whole arm and hand to work as a kinetic chain for transfer of motion to other parts of the body.

Other configurations of sleeves, straps, vests or other garment/device/support systems may be provided depending on the wearer's ability to move portions of their body, the particular disability the person may have, limb amputations or malformations, the stimulation and movement and body positioning desired, and other factors. The components of the present system may be used with other anatomic garment/device/support systems, for example to deliver tensions to other parts of the body. The sleeves may be used to attach to muscle groups on other parts of the body, including on the torso or the girdle. The sleeves may be attached to one another.

The straps may be connected to a seat cushion, such as a gel seat cushion, or back cushion to transfer energy to the portions of the wearer's body that is in contact with the wheelchair.

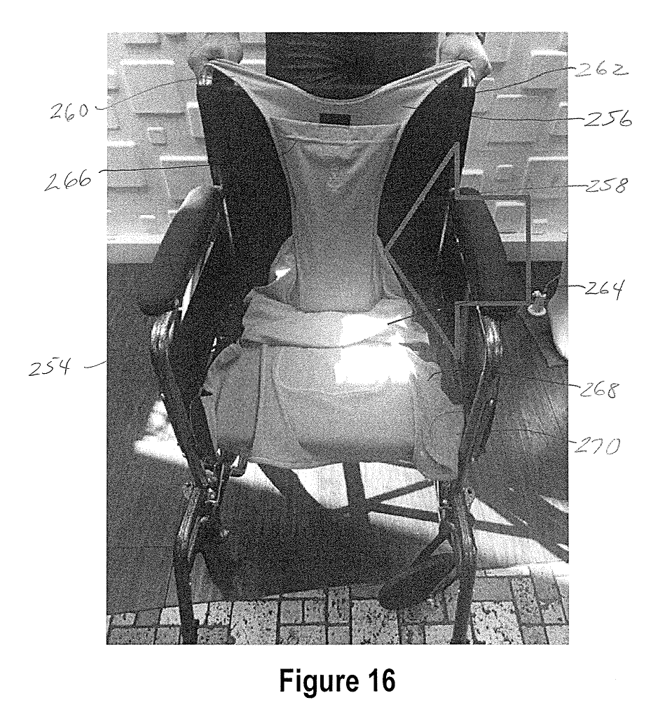

FIG. 16 is a frontal view of a wheelchair 254 on which is disposed a cape 256 that has a back portion 258 connected to shoulder straps 260 and 262. The back portion 258 includes a narrow center portion extending from the shoulder straps to a lower portion 264. The back portion 258 may include a pocket 266 providing a compartment into which may be placed a removable or built in structure to improve blood circulation, facilitate temperature applications via heating or cooling devices, for lumbar support and/or to alleviate pressure that stem from lack of mobility. For example, a massage apparatus may be located in the pocket 266. The lower portion 264 may include the side sections 216 that extend laterally for engagement of the wearer's lower torso, hips, or legs. Extensions 270 may be provided with fasteners for fastening the side sections 216 and extensions to articles of clothes worn by the wearer on the legs, hips, torso or other part. The cape 256 may include a pocket or fastener for the seat cushion described above.

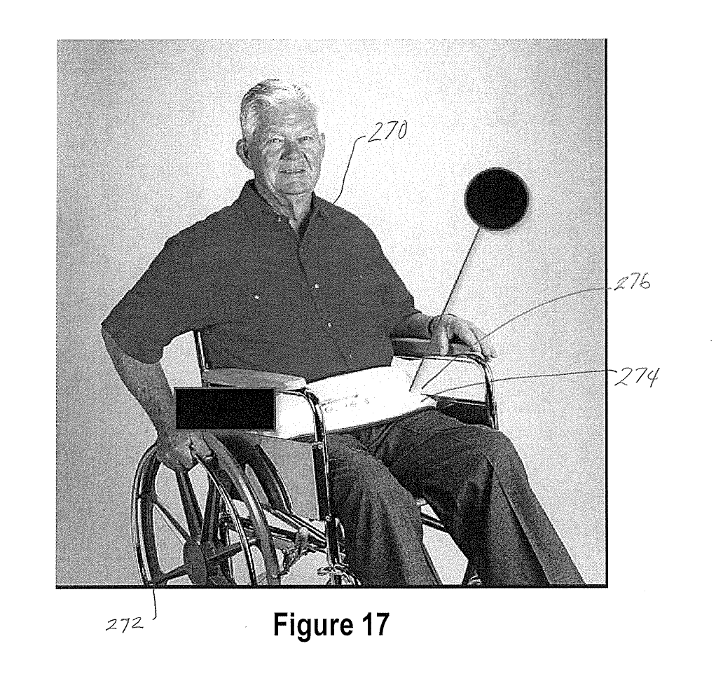

FIG. 17 shows a wheelchair user 270 seated in a wheelchair 272. The wheelchair user 270 is using a belt 274 to secure the user 270 in place in the wheelchair 272. The belt 274 may attach to or form part of the cape or vest, described herein. The belt 274 may include a lumbar support positioned at the user's lumbar area. A belt attachment 276 is provided, for example, at one or both sides of the user. The attachment 276 may include a retractable device attached to the belt. The retractable device is attached so that is may be moved from the frontal plane of the user to the sagittal plane, allowing an easy access. The retractable device may include a retractable arm that may be used to hold items for the user. In certain embodiments, the lumbar belt support is configured for inserting a retractable device that has the ability to hold other items for the individual. The retractable device may be a spring-operated cable retractor, for example, to which a user may attach items such as keys, wallet, ID cards, extended grippers, or other items that the user may wish to have at hand. A retractor device may be provided on both sides of the belt, or on only one side, or at other locations as may be convenient or desired by the user.

The present garment/device/support system may provide resistance to movement for the wearer, such as by tension on the chassis or vest of the garment/device/support system. The resistance may be similar to weight lifting or a resistance workout to improve the fitness of the wearer. A modulus is attached to the wearer's body so that the wearer's body becomes a weight lifting machine. The present garment/device/support system may be used in physical fitness regimens or for physical therapy for the wearer. The present garment/device/support system may be used to retrain the muscles or limbs. The present garment/device/support system may be used to restore and preserve neuromuscular anatomy and physiology. The present garment/device/support system may be used to promote body symmetry. Body symmetry is associated with beauty and health. As such, improved body symmetry may provide improved health and attractiveness. Equilateral body position and homeostasis may be improved. The garment/device/support system may be used by persons who have lost or diminished control. Specific muscle groups may be addressed. Biomechanical strain and controlled resistance that is modular it its placement is provided by the garment/device/support system.

The present garment/device/support system may influence the central and peripheral nervous system. Haptic response may be provided by the garment/device/support system. The influences provided by the garment/device/support system may provide cutaneous, kinesthetic, and haptic influence. Both passive and active means provide the motion and stimulation.

The present garment/device/support system, system and method may be of use by persons who are not wheelchair bound or who are not wheelchair bound on a full time basis. For instance, a person in a nursing home or rehabilitation facility that may be recovering from an illness, surgery, or may be prone to falling or have other medical or physical issues, may benefit from the body movement and stimulation provided by the present garment/device/support system and method, even if they have the use of their legs for example.

The stimulation and motion provided by the present garment/device/support system may help to prevent necrosis or other tissue deterioration.

Persons who are not in a wheelchair at all may benefit from the body movement and stimulation provided by the present garment/device/support system. For example, people who are unable to support themselves in particular positions may benefit from the present garment/device/support system. Persons healing from an injury or from surgery who are able to support themselves by their arms may benefit from the present garment/device/support system.

The present system may include a torso chassis that is constructed to transfer anterior force loads to posterior muscle groups in the upper extremity during the unconscious process of sleep.

The present system may include sleeves for the forearm of a wearer, wherein the sleeves terminate anywhere along the lower arm and can be anchored to other components.

The present system may include full arm sleeves that terminate in the upper arm and can attach to the chassis.

The present system may include an external cape attachment that has attachments from the wheelchair to the user.

Persons who have lost muscle-skeletal control, neurological control, or neuromuscular control may use the present garment/device/support system. A person with muscular dystrophy, or other disease or condition, may benefit from the present garment/device/support system.

Thus, there has been shown and described an apparatus and method and system by which motion, energy, and/or stimulation may be transmitted from one part of the body of a wheelchair bound person to another part of their body. Muscles, skin, ligaments, tendons, circulator system elements, and lymphatic system elements may be moved and stimulated. Viscera and organs may be moved and stimulated. Posture, body alignment, and body position may be improved. Body function and health may be improved.

A wheelchair bound person who has use of one or both arms may use the motion and energy of their arms to activate, stimulate, move and improve the health of other parts of their body using the present garment/device/support system.

Variations and different configurations, constructions, materials, and the like will be apparent to those of skill in this art. All such changes are within the scope of this invention.

Although other modifications and changes may be suggested by those skilled in the art, it is the intention of the inventors to embody within the patent warranted hereon all changes and modifications as reasonably and properly come within the scope of their contribution to the art.

We claim:

1. A device for wear by a wheelchair bound person, comprising:
a torso portion configured to be worn on at least a portion of the torso of a wheelchair bound person, the torso portion including attachment portions;
at least one sleeve configured for wear on a limb of the wheelchair bound person; and
at least one strap connected between the at least one sleeve and the torso portion, the strap transferring motion from the movement of the limb to other portions of the person's body.

2. A device as claimed in claim 1, wherein the torso portion has a first fastener portion, and wherein the at least one strap has a second fastener portion for attachment to the first fastener portion.

3. A device as claimed in claim 2, wherein the first fastener portion includes a Velcro receptive panel on the torso portion, and wherein the second fastener portion includes a Velcro fastener configured for attachment to the Velcro receptive panel.

4. A device as claimed in claim 1, wherein the at least one sleeve includes a lower arm sleeve having a wrist end and an elbow end; wherein the at least one strap extending from the elbow end and having an opposite end for selective fastening to at the torso portion.

5. A device as claimed in claim 1, wherein the at least one strap includes first and second straps extending adjacent one another from the at least one sleeve from a first end connected to the at least one sleeve to an opposite end.

6. A device as claimed in claim 5, further comprising: a transverse strap extending transverse of the first and second straps adjacent to the opposite end.

7. A device as claimed in claim 1, wherein the torso portion includes a circular or oval portion formed at a scapular portion of a back of the torso portion.

8. A device as claimed in claim 1, wherein the at least one sleeve includes an elbow band at a first end of the sleeve and first and second straps extending adjacent one another from the elbow band to an opposite end.

9. A device as claimed in claim 8, further comprising: a transverse strap extending transverse across the first and second straps adjacent the opposite end.

10. A device as claimed in claim 1, wherein the torso portion includes a lower portion configured for encircling hips of a wearer so as to transfer energy from movement of a wearer's arms to the wearer's hips.

11. A device as claimed in claim 1, further comprising:
a lower leg sleeve configured for wear on a lower portion of a wearer's leg and at least one strap connected to lower leg sleeve for attachment to the torso portion.

12. A device as claimed in claim 1, further comprising:
a cape having a back portion and first and second shoulder straps connected to the back portion, fasteners on the first and second shoulder straps, the back portion configured for extending beneath a wearer's buttocks when the wearer is seated.

13. A device as claimed in claim 12, further comprising: side portions extending laterally from the back portion of the cape, the side portions having fasteners and being configured for fastening at one of hips or thighs of a wearer.

14. A device as claimed in claim 12, further comprising: a seat cushion configured for fastening to the cape.

15. A device as claimed in claim 1, further comprising:
at least one glove including a hand portion and finger portions;
a plurality of strips affixed to or formed into the at least one glove, the plurality of strips extending along a front and back of each of the finger portions.

16. A device as claimed in claim 1, further comprising:
a belt configured for wear around a wearer's waist, the belt including a lumbar support.

17. A method for transferring motion and energy from an arm of person in a wheelchair, comprising:
applying tension to straps extending from the person's elbow to the person's shoulder during movement of the person's arm while seated in the wheelchair; and
transferring the tension from the straps to the person's torso by a vest connected to the straps and worn by the person so that movement of the person's arm stimulates tissues or organs of the person.

18. A method as claimed in claim 17, further comprising:
applying tension to a cape extending from the person's shoulders over a back of the person's torso.

19. A method as claimed in claim 17, further comprising:
transferring the tension from the straps to the person's hips or legs by one of a vest and a cape.

20. A method as claimed in claim 17, wherein the applying includes applying tension to straps extending from sleeves on both arms of the person, the straps transferring the tension of motions by both arms to tissues or organs of the person via the vest.
